(19) United States
(12) Patent Application Publication
(10) Pub. No.: US 2022/0038196 A1
(43) Pub. Date: Feb. 3, 2022

(54) CROSS PLATFORM APPLICATION FOR SHARED SPECTRUM OPERATIONS AND CERTIFIED PROFESSIONAL INSTALLER MANAGEMENT

(71) Applicant: Zaheer Syed, Ashburn, VA (US)

(72) Inventor: Zaheer Syed, Ashburn, VA (US)

(21) Appl. No.: 17/389,325

(22) Filed: Jul. 29, 2021

Related U.S. Application Data
(60) Provisional application No. 63/058,304, filed on Jul. 29, 2020.

(51) Int. Cl. H04B 17/391; H04W 16/22; H04B 17/318

(52) U.S. Cl. CPC H04B 17/391; H04B 17/318; H04W 16/225

(57) ABSTRACT

A cross-platform application is disclosed for shared spectrum operations and CPI management. The application and platform provide an exchange of information usable for CPIs to improve collection of the information required for reporting to the SAS. Some embodiments provide methods to map a floor plan by ray tracing to provide some of the information. In another embodiment, a method includes generating contour information of a floor(s) from two-dimensional and three dimensional models.

### CROSS-REFERENCE TO RELATED APPLICATION

This application claims benefit under 35 U.S.C. § 119(e) of U.S. Provisional Application having Ser. No. 63/058,304 filed Jul. 29, 2020, which is hereby incorporated by reference herein in their entirety.

### FIELD

The subject disclosure relates to a cross platform application for Shared Spectrum Operations and certified professional installer (CPI) management.

### BACKGROUND

The FCC, in Part 96 released for the first time, in its history, a three-tiered spectrum model, where a swath of the electromagnetic spectrum used by DoD and other users, that is minimally used, is released to commercial users on a shared basis. This band can be shared on time and space basis with commercial users. This frequency band is called the Citizens Broadband Radio Service (CBRS) band and lies between 3550 MHz to 3700 MHz. The Incumbents or Tier 1 users of this band are Navy radar systems, Fixed Satellite Stations, Grandfathered Broadband Wireless links and FCC field offices. FCC created rules for commercial users to use this frequency band thorough various rule makings that are codified in CFR 47 Part 96. These rules are commonly referred to as Part 96 rules. In its policy, it created two new Tiers of users in the band. The two new tiers: 1. Tier 2 or Priority Access License, is for licensees who can purchase a slice of spectrum for a fee, provided they comply with the CBRS rules and meet a performance criterion. The length of the license period for the PAL users is 10 years and the license area is at a county level. This use is similar to Licensed Spectrum purchase by an entity; however, it has to work within the rules of CBRS. Tier 3 or the General Authorized Access, are free to use the spectrum as long as they are not interfering with the Tier 1 and Tier 2 users.

The Devices that are to use this spectrum are termed as Citizen's Broadband Radio Service Devices, aka CBSDs. The Part 96 rules have created three categories of devices.

EUDs: End User Devices, that operate within 23 dBm

Category A Devices, that operate within 30 dBm.

Category B Devices, that operate within 47 dBm.

Category A and Category B devices are required to register with the Spectrum Access System (SAS), which is the central entity that plays the role of protecting Incumbents and providing the CBSDs access to spectrum for transmission and operation. Each category of CBSD is required to register its location either automatically or manually with the SAS, so that the SAS can estimate if the CBSDs are interfering with Incumbents or not.

The FCC has defined certain accuracy parameters in both the horizontal and vertical plane for location registration. The higher-powered Category B devices cannot be installed Indoors and are required to be installed and verified by a Certified Professional Installer.

The Certified Professional Installer (CPI) is required to undergo training by a Accreditation agency, pass and exam and carry a validation certificate, for a duration of 5 years. A CPI is required to renew this certification at the end of 5 years. A CPI is also expected to keep himself/herself updated on newly published rules and changes that the FCC may publish. The liability of capturing and reporting the location and registration parameters solely rest with the CPI.

A CPI is also required to report the accurate location of the Category A CBSDs in indoor spaces, if there is no automatic geolocation capability possible within the CBSD. The typical accuracy requirements expected of a CBSD location in within +/−50 meters on the horizontal plane and +/−3 meters on the vertical plane. +/−3 meters could easily mean that the difference in installation on a different plane.

A CBSD has to explicitly declare that it is operating Indoors for the SAS to account for a default Outdoor to Indoor Signal penetration loss, also called Building Entry Loss. The default value that has been advised by the FCC is 15 decibels.

### SUMMARY

In one aspect of the disclosure, a computer program product for generating building entry loss measurements used by certified professional installers of telecommunications equipment is disclosed. The computer program product comprises a non-transitory computer readable storage medium having computer readable program code. The computer readable program code is configured, when executed by a processor, to: receive a request from a user, through an application programming interface (API) of a computing device, to determine a building entry loss for a wireless equipment asset located in an indoor space. Vector rays emanating from the wireless equipment asset in the indoor space are drawn in incremental angles toward an exterior of a building housing the wireless equipment asset. For each vector ray, building entry loss in each angle of an outdoor signal on its path to the wireless equipment asset is calculated.

In another aspect, a method for generating building entry loss measurements used by certified professional installers of telecommunications equipment is disclosed. The method includes: receiving a request from a user, through an application programming interface (API) of a computing device, to determine a building entry loss for a wireless equipment asset located in an indoor space; drawing vector rays emanating from the wireless equipment asset in the indoor space in incremental angles toward an exterior of a building housing the wireless equipment asset; and for each vector ray, calculating building entry loss in each angle of an outdoor signal on its path to the wireless equipment asset

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 is a block diagram of a system for shared spectrum operations and CPI management in accordance with exemplary embodiments.

FIG. 2 is a block diagram of an architecture for functions in the system of FIG. 1 in accordance with exemplary embodiments.

FIG. 3 is a flow chart of a process for data processing in accordance with exemplary embodiments.

FIG. 4 is a screenshot of a web-based user interface displaying network activity and an associated installer for a project in accordance with exemplary embodiments.

FIG. 5 is a screenshot of a web-based user interface displaying SAS editing functionality for a project in accordance with exemplary embodiments.

FIG. 6 is a flowchart of a method for generating a building loss map of a CBSD environment in accordance with exemplary embodiments.

FIG. 7 is a screenshot of a web-based user interface (UI) displaying asset data in accordance with an embodiment.

FIG. 8 is a screenshot of a web-based UI displaying polygon boundaries of signal zones in accordance with an embodiment.

FIG. 9 is a screenshot of a web-based UI for importing floor plans of a building into an API in accordance with an embodiment.

FIG. 10 is a screenshot of a web-based UI displaying a map of outdoor deployment locations in accordance with an embodiment.

FIG. 11 is a screenshot of the web-based UI of FIG. 10 displaying an overlay of information for a selected CBSD in the map in accordance with an embodiment.

FIG. 12 is an enlarged window from the UI of FIG. 11, showing data entry fields of antenna characteristics for the selected CBSD in accordance with an embodiment.

FIG. 13 is a screenshot of a UI displaying a map of a floor plan for a building for indoor deployment locations in accordance with an embodiment.

FIG. 14 is a screenshot of a UI function for automatically generating a grid array antenna (GAA) coexistence file for a building in accordance with an embodiment.

FIGS. 15A, 15B, and 15C are screenshots of mobile device UIs for creating a wireless equipment asset in accordance with an embodiment.

FIG. 16 is a screenshot of a mobile device UI for determining outdoor data related to an asset for CBRS information in accordance with an embodiment.

FIG. 17 is a screenshot of a mobile device UI for determining terrain information for an asset in accordance with an embodiment.

FIG. 18 is a screenshot of a mobile device UI for determining antenna tilt for an asset in accordance with an embodiment.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labeled with identical element numbers for ease of understanding.

In general, and referring to the Figures, exemplary embodiments of the subject technology address the following problems:

Given that the Shared Spectrum is a new paradigm in the United States, installers and CPIs have to contend with learning new platforms and new procedures to input CBSD Registration data into either the Domain Proxies (a Domain Proxy acts as an aggregation entity for various CBSDs to communicate to the Spectrum Access System (SAS)) or even directly into the SASs. There are aspects of information that can be provided by both the CBSD and the installer into the SAS to complete the set of Information for a SAS to complete the CBSD Registration. The variabilities in system entry require extensive training and at the same time, each SAS or Domain Proxy can have different software versions and release features, an installer or CPI has to contend with.

In one aspect, the subject technology comprises a standardized cross platform information exchange and query portal that works across one or more SAS and one or more Domain Proxies.

As described in the background section, the liability of verifying, validating a CBSD install, whether outdoors or in all cases, where the CBSD is unable to geolocate itself lies with the CPI. The CPI is expected to understand per WInnForum guidelines the errors and attributes that a SAS may use to respond back to the CPI to indicate an erroneous installation. A SAS may also indicate to the CPI that a particular CBSD category has to be changed from the lower power Category, Category A to Category B, if it does not meet the Height Above Average Terrain (HAAT) considerations. Further a CPI is expected to enter accurate information and complete information in the correct formats to the SAS. If the information is incomplete or incorrect, the SAS rejects the submission.

In another aspect, the subject technology comprises a standardized method for a CPI to collect the information required for reporting to the SAS that meets the FCC and WInnForum requirements. Aspects of the subject technology help the CPI record and collect evidence of their submissions and generate visual aids that may be used in cases of FCC violation reports. The system may enable documentary evidence collection of the information that is submitted to the SAS and may also collects the evidence with a timestamp. This is pertinent, especially if a third party or someone who is unfamiliar with the CBRS requirements have either relocated or changed the parameters in a way that may implicate the CPI.

CBRS networks are expected to be primarily deployed on 4G LTE and 5G NR technology. Traditionally these technologies have been deployed on licensed frequencies, where the cellular service provider have exclusive access the spectrum and possess absolute control over where and how the networks are deployed. The Cellular Network Service Providers, with their licensed spectrum are able to coordinate their own interference and do not interfere with other wireless operators. On the other hand, users of Wi-Fi using 802.11 technologies use built-in interference coordination mechanism called Channel Sense Multiple Access to avoid interference. This mechanism protects against interference from the Radio to End User and from the End User to the Radio equipment. In effect CSMA senses the transmission medium for any competing transmission, and if it does sense a transmission in progress, it turns of its radio and retries the medium ,after a random time to find an opportunity to transmit or receive. However, with CBRS, for the first time ever, technologies that were primarily used in the licensed spectrum are applied in within a concept of shared spectrum using a coordination mechanism, that is nor locally aware. The CBRS spectrum promises opportunity for small and large operators to operate their own private networks to serve specific business use cases in factories, educational and other general locations.

The SAS or Spectrum Access System is a central entity that attempts to coordinate the operation and interference of all CBSDs within the US. Its primary responsibility is to estimate and model interference in a location and primarily protect the Incumbents of the CBRS band and secondarily provide opportunistic access to spectrum for one or more CBSDs. While the interference mitigation rules have been spelled out under Part 96 for Incumbent protection, the Interference Protection framework for inter-operator coordination has been left to the industry. The SASs uses ITM propagation and modelling every day to assess interference to Incumbents and uses the same information to assign spectrum to the commercial CBSDs. While the SAS is able to leverage modelling for Outdoor settings efficiently due to available Terrain and Clutter information collected via Satellite and Aerial Imagery, it is unable to do so for coordination between Outdoor to Indoor or Indoor to Indoor CBSD interference. And further there are no mechanisms defined where the CBSDs belonging to different Service Providers can directly interact to coordinate interference. In Indoor settings, the SAS does not possess the knowledge of environment, indoor spaces and the nature of materials in that space. This severely impacts the extent of the signal that is penetrating into the building or leaving the building. A SAS uses a default attenuation factor or popularly referred to as Building Entry Loss (BEL) of 15 dB to account for outdoor to indoor signal penetration loss. A SAS applies this default value for all indoor CBSDs regardless of where the CBSD is located in the indoor space. An indoor CBSD located in the basement or at the 50th floor is provided the same treatment.

The same treatment of Building Entry Loss of 15 dB to all indoor CBSDs may result in highly inefficient use of the CBRS spectrum. Given that the number of Indoor CBSDs deployed are expected to be much larger than the number of Outdoor CBSDs, a better way for information exchange for a SASs Interference coordination is key. If a CBSD can describe its location accurately within an Indoor setting and along with it, is able to present the local environmental information, such as surrounding walls, doors, distance to the exterior of the wall, floor and its position in (x, y, & z) axes (also may be referred to as lateral, longitudinal, and vertical position) from a datum point, this information can be used by one or more SAS to perform interference coordination and management of Time Synchronized networks with efficiency. When such information is exchanged with the SASs, is matched with CBSD locations from other operators, this empowers the SAS and its logical entities to build interference graphs for effective channel distribution and interference management. This entire information sharing of an operator's CBSDs along with other operators CBSDs can be communicated to the SAS for improved Spectrum efficiency. Embodiments of the subject technology provide this improved environmental information.

Another aspect of the subject technology comprises a novel method of reporting and characterizing of a CBSDs environment, the Building Entry loss in all directions and FCC signal contours. This information may be communicated to one or more SAS to encourage information exchange and drive efficiency of CBRS spectrum.

### Overview of the Subject Technology

Embodiments of the subject technology comprise a collaborative Cloud-based and Mobile Application based process, that is designed to normalize the information flow from the field personnel to one or more Spectrum Access System or Domain Proxies to achieve the following:

A method to combine CBSD Registration parameters with CBSD provisioning in a vendor agnostic fashion.

A method to find the best signal available at a particular location by sorting and prioritizing one or more Base Station Signals at a given location.

A method to validate and cross verify CBSD registration information with FCC and other National databases to minimize Installer errors.

Contain a visual GIS based aid to finalize the best among multiple signals using the “Network Map” module.

A method to remove variabilities and tracking dependence of various SAS portals, API calls, logging & Analytics options of different end systems.

A standard method to query and display the status of a CBSD within a SAS and shared spectrum parameters such as amount of Spectrum granted and power granted in a particular location and trending it historically. This historical trending is captured across multiple SASs to help the user to select end systems that provide the best value for the money.

The system for an indoor venue, provides a method for a CPI or an installer to record the location of the CBSD within an Indoor Setting and capture its environment, towards calculation of “Reverse Building Entry Loss” that may be characterized in two ways.

As used herein, a piece of radio equipment that is the subject of installation and/or registration/updating, may be referred to as an asset. An asset may be for example, a radio transceiver and is sometimes referred to as a CBSD. These terms may be used interchangeably throughout the description below.

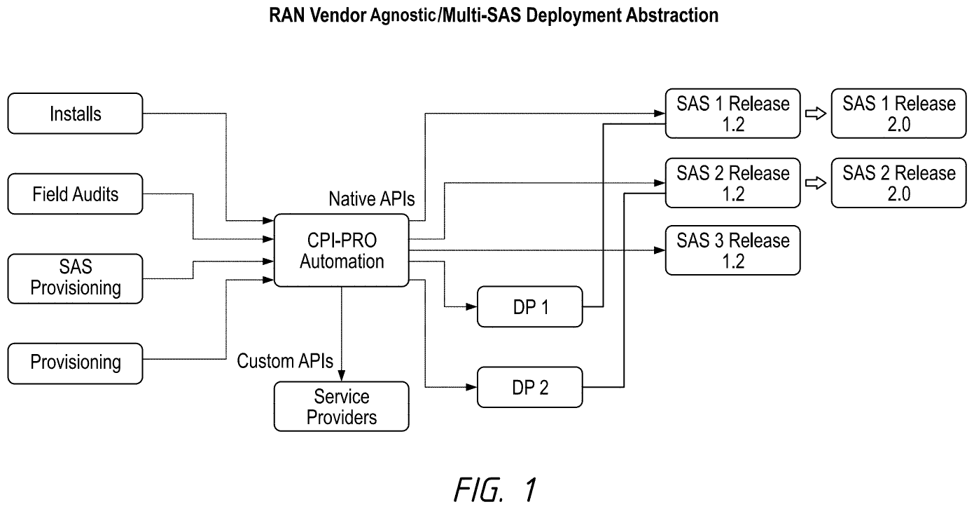

Referring now to FIG. 1, a system for shared spectrum operations and CPI management is shown according to an exemplary embodiment. As will be appreciated, aspects of the system may be vendor agnostic and may provide multi-SAS deployment. One embodiment of the subject technology is represented by the block labeled CPI-Pro Automation, which represents an online platform integrating data gathered from installs, field audits, SAS provisioning, and other provisioning and generating processed data compliant with multiple release versions of SAS. While specific SAS versions are shown, the platform may update as SAS versions update to continue to provide compliant information that is vendor agnostic. In some embodiments, the platform includes native APIs which may be compatible with the requirements of multiple service providers. Some embodiments may remain compatible with customized service provider APIs. The data from the platform may be forwarded to domain proxies (“DP”s) that aggregate the data before passing the data to SAS entities.

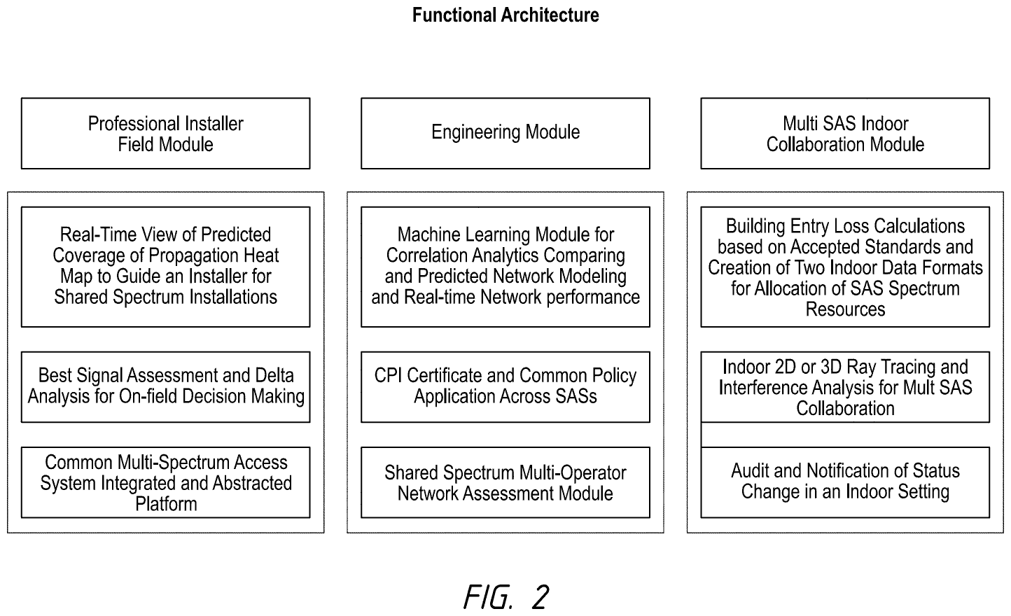

FIG. 2 shows a functional architecture in accordance with an exemplary embodiment. The architecture may generally include a professional installer field module, an engineering module, and a multi-SAS indoor collaboration module.

The professional installer field module may include various features for installer assistance during a field installation. For example, the field module may be configured to provide real-time views of predicted coverage for a propagation heat map. As will be appreciated, the generated predicted coverage may be useful to guide an installer during shared spectrum installations of radio devices. The field module may include in some embodiments a best signal assessment and delta analysis for on-field decision making. Other embodiments may include a common multi-spectrum access system integrated and abstracted, so that the signal assessment and delta analysis are decouple from underlying SAS communication formats and APIs. The features may be provided through web or mobile device APIs (some examples of which are shown below).

The engineering module may include a machine learning module. In an exemplary embodiment, the machine learning module may be configured to provide correlation analytics, where modelled Radio Signal Propagation, attained from commercial modelling tools can be compared and correlated against field measurements. While the modelled Radio Signals assume a single operator, the field measurement contains actual radio signals from all the operators in the environment. Given that an operator has only visibility to their own CBSDs, the common measurement and correlation engine provides a method for a multi-operator network assessment module. This module assembles the transmissions from all the CBSDs in an indoor environment and provides this information to multiple SASs who are supporting the CBSDs in the local environment. The module serves as a glue for different CBSD operators who are subscribing to different SAS providers.

The Multi SAS indoor collaboration module provides features related to indoor signal measurements that can be used among different installation entities. For example, one feature includes a building entry loss calculation. The system may calculate loss based on accepted industry standards. Some embodiments may include a creation of two indoor data formats for allocation of SAS spectrum resources. Some embodiments of the collaboration module may generate two dimensional or three dimensional ray tracing and interference analysis for multi SAS collaboration. The module may be configured as a common module to query the SAS(s) of all available CBSDs in a given building and floor and utilize this information to model CBSD radio propagation and interference caused to each other. Some embodiments include an audit or notification of status change in an indoor setting. As may be understood, different operators deploy the CBSDs at their own accord and the environment constantly evolves depending on if CBSDs are deployed Outdoor or Indoor. The Audit mechanism, specifically can be used to correct the location of the install of the CBSD within an Indoor setting. A CBSD installed in one conference room marked erroneously as in the hallway, can cause different Interference assessment.

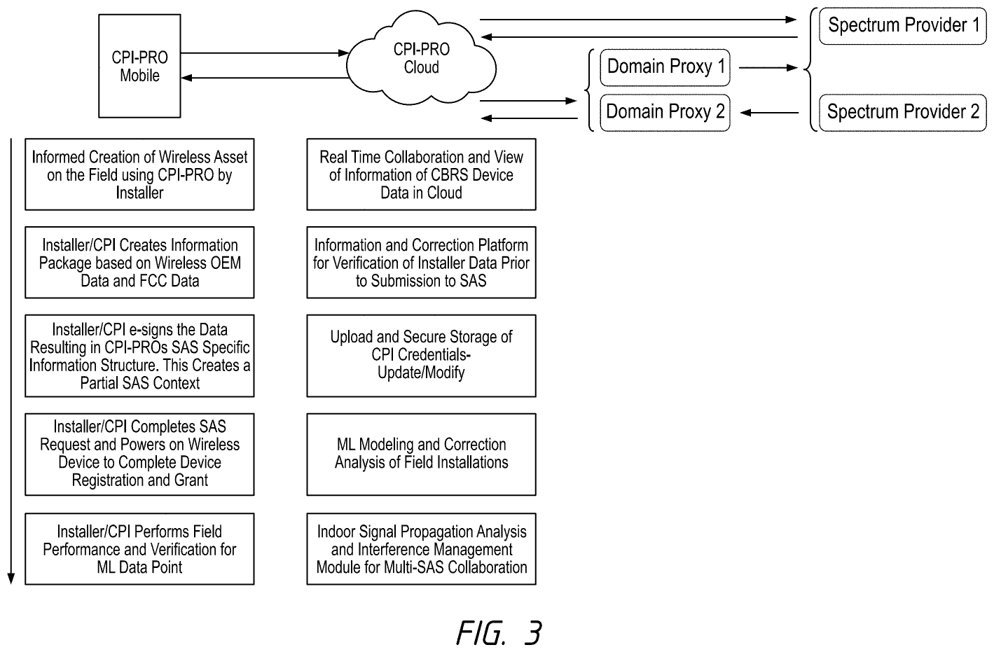

Referring now to FIG. 3, a method of generating shared spectrum signal analysis on shared platform is shown according to an exemplary embodiment. The process may include input from a field technician user that is processed by a host server(s) resident in a cloud based network.

The field technician may input data through an API or UI of a mobile computing device or web based UI. The process generally begins with the creation of a wireless asset input into the API, by an installer technician, while in the field. The wireless asset may be for example, a wireless radio transmitter. The installer creates an information package based on wireless OEM data and FCC data for the wireless asset. The API may be configured to receive an electronic signature of the installer for the information entered. The API receives an indication that the SAS request is completed. Powering on the wireless asset completes the device registration and grant for operation. The installer may perform field performance and verification of performance. The performance data may be used for machine learning by the system.

At the host level, real-time collaboration and view of CBRS data is provided to end user devices running the platform's API. The host may provide information and correction of installer provided data prior to submission to SAS. As may be appreciated, this ensures that the data shared with multiple entities is reliable. The verification process may involve interpreting Errors and Cause Codes that are provided by the SAS upon erroneous formats or wrong information submission. Mobile application embodiments may include a built-in format correction process that addresses the information correction via multiple sub-modules. For example: 1. Azimuth Finding sub-module supported by Magnetic Declination vs True North calculation, 2. AGL/AMSL with HATT calculation that supports Category A or B decision, Horizontal Coordinate definition that complies with reporting accuracy, Indoor Multi-Floor Height Reporting Aggregation for overall CBSD height reporting to SAS in z axis. Some embodiments include receiving uploads and storage of CPI credentials, which may be modified and updated when modified.

In an exemplary embodiment, the host server may include a machine learning module which models field installations and provides correction analysis when the model predicts insufficient radio signal strength to meet expected modulation and coding schemes to meet specific bandwidth requirements or provides threshold triggers when estimated interference potentially impacts the performance of the system under consideration.

Another module in the host platform may be configured to provide indoor signal propagation analysis and interference management. This module captures, indoor environment, where the environment around the CBSD is modelled and placed within a layout file, that describes, the walls, the materials, the material properties in such a way that multi-operators can share the same layout format to assess interference to each other. The output of such modelling is saved in for example, a Geo-Aware format in a Geo-Aware Database. The geo-aware dataset is codified in common geo-aware formats such as GeoJSON for easy portability. The dataset contains specific details of the CBSD environment, specific azimuth specific intersections, number of walls and multi-floor interference estimation, multi-operator CBSD location information, so that it can be shared across multiple SASs. This module uses standard NAD83 mapping format that is common across multiple commercial mapping platforms. Such output is built in two specific ways: 1. An output that contains the environment of the CBSD, the CBSD view towards the edge of the building, other pertinent details on Building, Floor, Floor Height and 2. All details in 1. And interference modeling information with its signal indicators. These two formats can be provided to the SASs depending on their preference.

The host platform information may be forwarded directly to spectrum providers or through domain proxies.

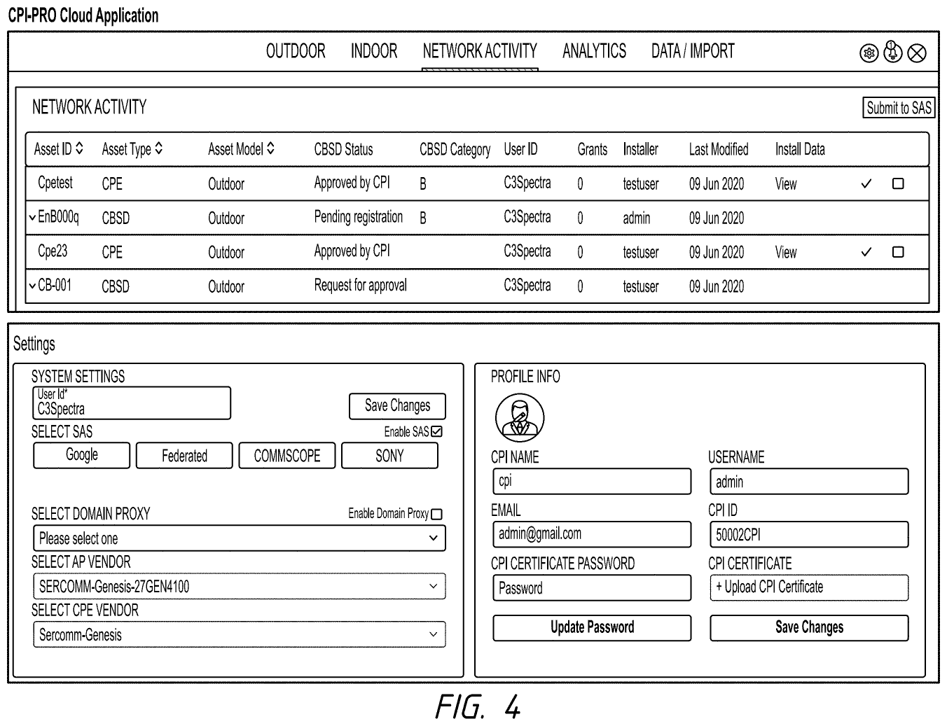

FIG. 4 shows a user interface showing network activity in shared spectrum environment according to an exemplary embodiment. The field installer may register the information for a selected wireless asset. The information may be compliant with all the requirements for CBSD Registration. The installation may be tracked with the identification of the installer whose profile may be readily submitted to complete the registration requirements.

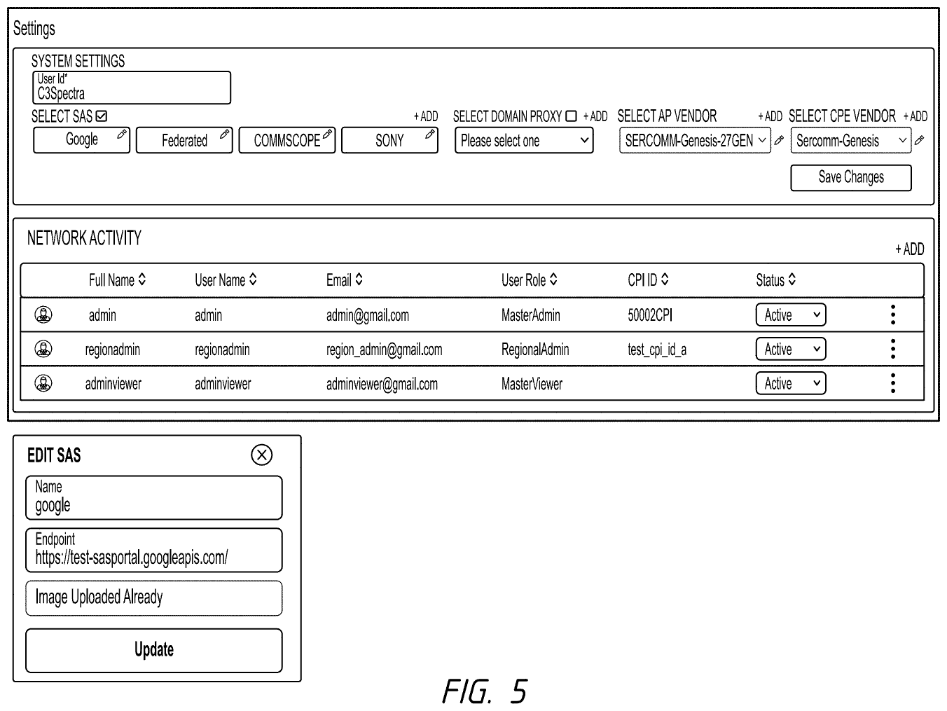

FIG. 5 shows a UI for conveniently editing SAS information according to an exemplary embodiment.

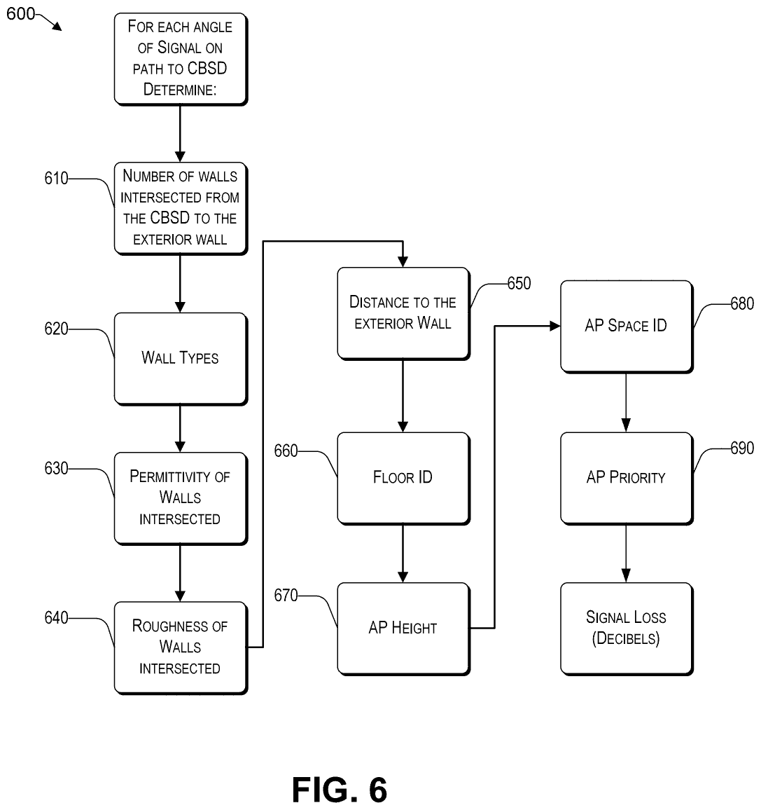

Referring now to FIG. 6, a process 600 for generating a building loss map of a CBSD environment is shown according to an exemplary embodiment. The process may be automated using a topography calculation feature through the API of the subject technology. In an exemplary application, the feature is configured for use indoors. The feature may characterize a CBSD's surroundings in incremental degrees by mapping GIS map drawn vector rays with respect to a datum point, (for example, along True North), after creation of a GeoCoded Floor Plan by taking into account the following attributes for a SAS to calculate the Building Entry Loss from every direction of the building. In an exemplary embodiment, to capture mapping data, there may be two options in the tool available through the software interface. 1. Capture the building information per floor using a hand-held laser scanner, where the Point Cloud information is reformatted to serve as an input to the tool or a user can upload a FloorPlan Image and create a geo-trace of the floor plan. The manual tracing, though cumbersome provides an opportunity to create these measurements. The system processes the captured data to determine the vector rays.

Each vector ray provides the following information to the central SAS entity to calculate Building Entry Loss in each angle of an outdoor signal on its path to the CBSD.

Block 610: number of Walls intersected from the CBSD to exterior wall in path of exterior signal.

Block 620: Type of Walls intersected (for example, by material(s) in wall). In some instances, the signal may travel through other objects including for example, doors, windows equipment, furniture, and other obstructive objects. Each object may be considered a “wall” for purposes of calculating signal loss.

Block 630: Permittivity of Walls intersected.

Block 640: Roughness of Walls intersected.

Block 650: Distance to the exterior Wall from CBSD.

Block 660: Floor ID, which may comprise the floor level of the area being assessed (for example, the 8th floor).

Block 670: Access Point (AP) Height. As will be understood in the field, an access point may also be understood to be a transceiver or a CBSD.

Block 680: AP Space ID

Block 690: AP Priority

The data collected maybe stored as GeoJSON files with the properties of walls, windows and doors and their dimensions, and materials and a JSON file containing the above information.

In another embodiment, a method involves calculation of popular Path Loss models such as the Multi Wall Model or the Indoor Hotspot 3GPP module into a Ray Tracing engine to provide contours in the 2D and 3D format. The contours are an outcome of the calculation for a specified threshold. The 2D contours are combined with the Geocoded Floor plan provided to the SAS. The 3D contours for multiple floors are combined along with multiple floors to the SAS, where multiple floors are involved.

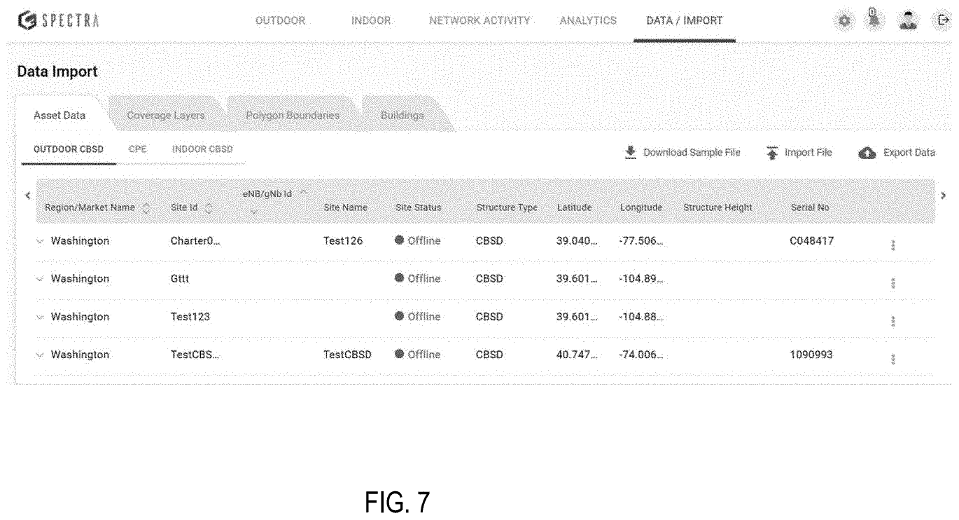

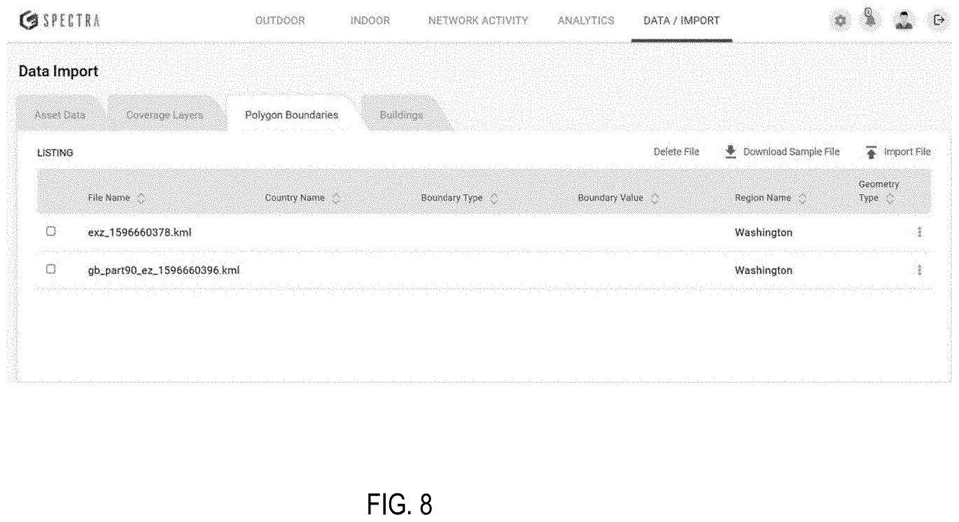

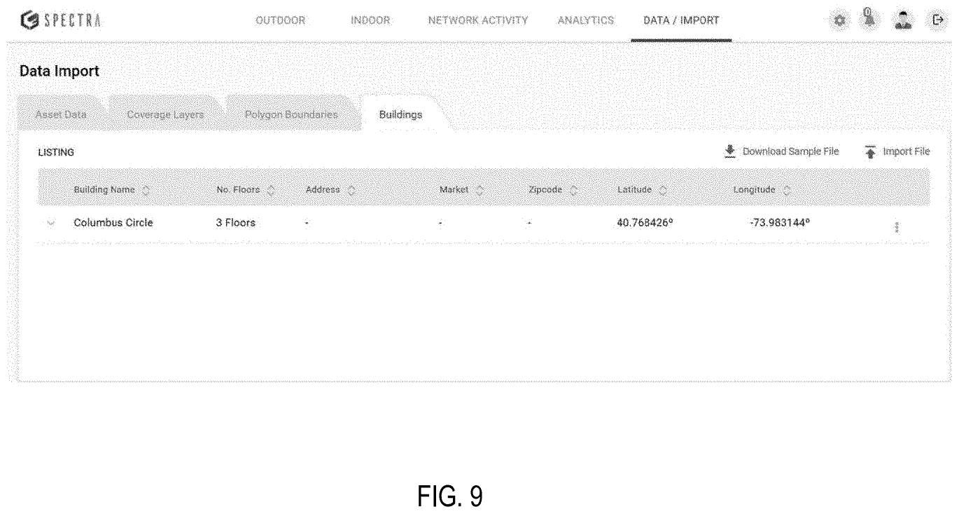

FIGS. 7-18 show screenshots of web-based and mobile computing device based electronic display interfaces (UIs and APIs) to illustrate some of the features of the subject technology in accordance with exemplary embodiments. While some UIs are described as being web-based or mobile device based, it will be understood that the content of the UIs and their functional performance may be adapted for one or the other (web-based versus mobile device).

FIGS. 7-9 show an interface configured to synchronized with the field application in such a way that a CPI can work with engineering and other collaborators to meet the accurate work flows and accuracy needs of CBRS.

In addition the interface provides a platform for setting parameters and URLs to make interaction with one or more SAS seamless and real time. Once the data is submitted to the SAS, the CBSD can request the spectrum grants. The interface may be hosted on the Cloud for easy access for all the users. Defining the overall setup of URLs, CBSD, FCC certification, etc. is made possible via the application.

In an exemplary embodiment, FIGS. 7-9 show a data import page. The data import page creates all the needed context for a CPI and Non-CPI to work with the application. An exemplary embodiment may have four categories of information that helps a service provider to work with CBRS systems seamlessly and integrate with APIs to internal business applications.

Site Information: This information can be imported into the application via a pre-defined template that contains parameters for a service provider to define attributes that can be combined with CBRS parameters. This helps the service provider or operator to not modify their internal systems drastically to take advantage of CBRS spectrum.

Coverage Files: These include an operator's service or heatmaps where they intent to provide coverage for various service levels.

Polygon Boundaries: This aspect of the application allows a user to import the FCC/NTIA defined Incumbent CBRS Use/or exclusion zones, so that the operator and their CPIs are aware of zones, where they are not allowed to install or operate their networks.

Buildings: An operator that intends to deploy CBRS in indoor venues, can import one or more floor plans to support creating CBRS assets and report them to the SAS.

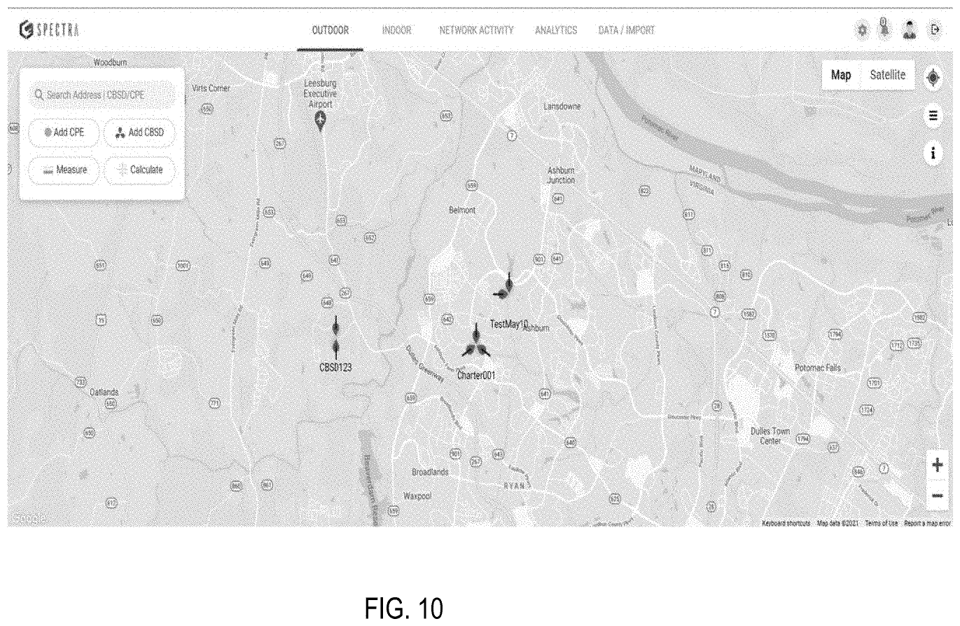

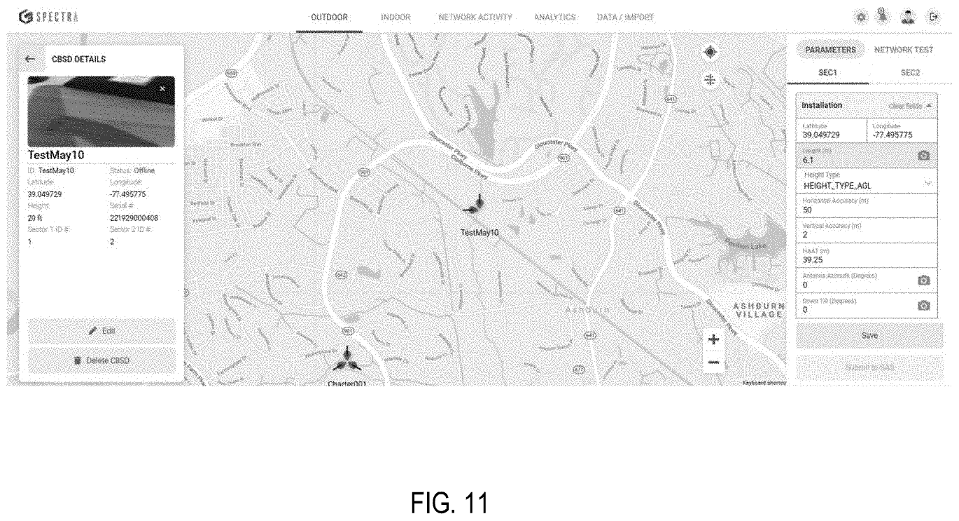

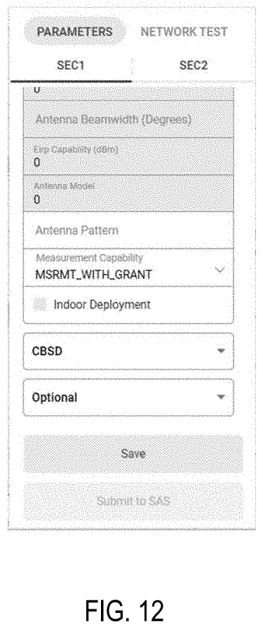

FIGS. 10-12 show UIs and functions for outdoor deployment according to an exemplary embodiment. The Outdoor deployment section captures asset or CBSD Creation for all outdoor deployment types. One has the same ability of creating, modifying the assets and updating the information, similar to the field application. FIG. 10 shows a UI that allows a user to add a CPE or a CBSD to a map. FIG. 11 shows a pop-up overlay window of information for a selected CB SD in the map. A side window (shown enlarged in FIG. 12) provides installation parameters for the asset.

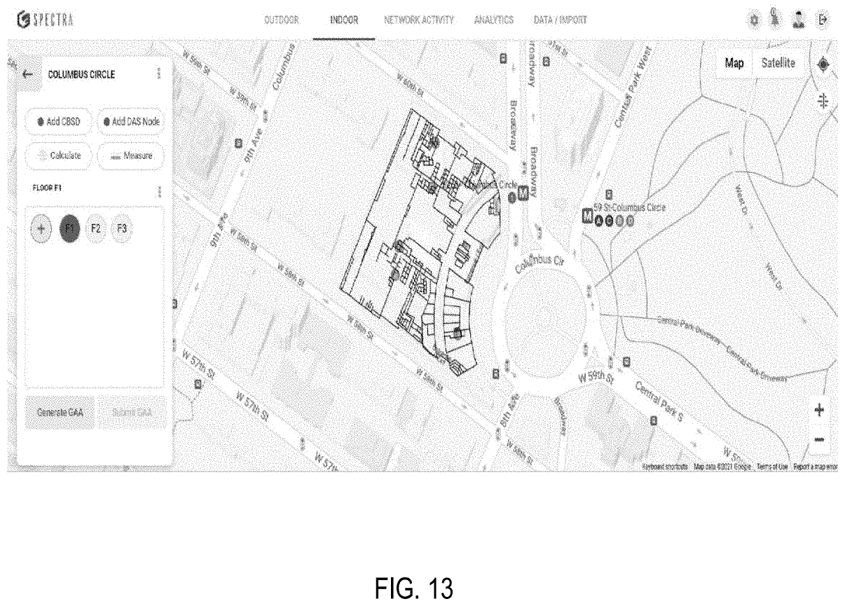

FIG. 13 shows a UI for an indoor deployment environment according to an embodiment. A user may select a building in the map and a floor plan for a selected floor may be shown. As can be seen, the example building has three floors, so any floor in the records of the building may have an associated floor plan displayed. The floorplans show walls, doors, windows, or any other obstruction that may affect a radio signal within the indoor environment. The user may add a CBSD location to the floorplan. Aspects of evaluating the signal strength, interference, and other characteristics related to the addition/registration of an asset may be performed based on an actual or proposed location of an asset in the indoor environment.

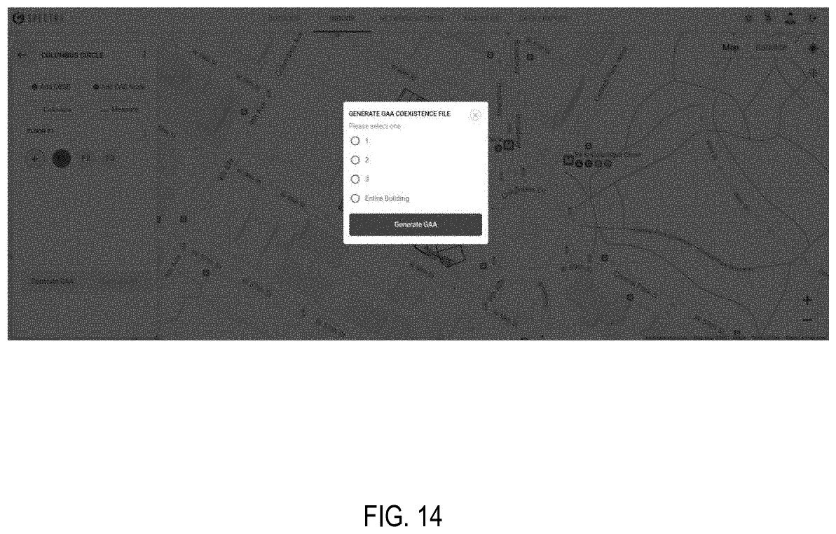

FIG. 14 shows a UI for generating a GAA co-existence file. Embodiments may include generating the GAA file for a selected floor or the whole building.

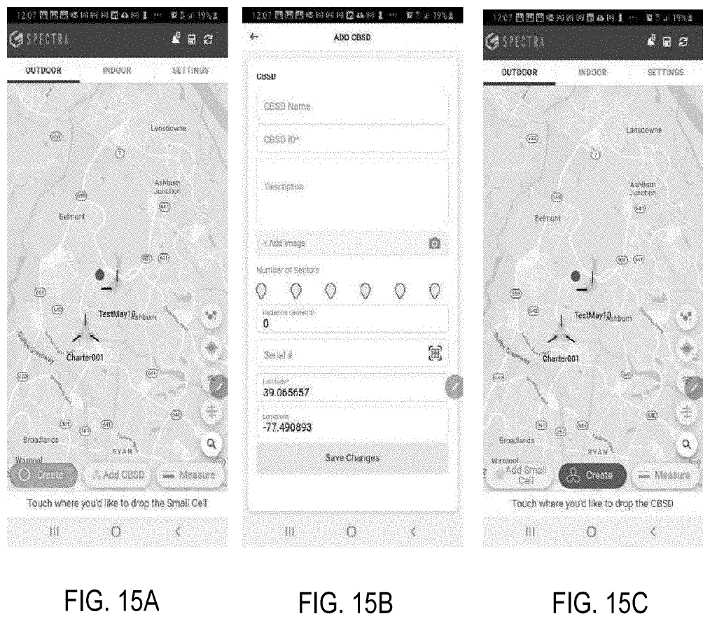

FIGS. 15A-15C and 16-18 show exemplary UIs for a mobile device application. In general, the mobile device interface is configured as a field adapted version for collecting CBRS information that provides data gathering complying with CBR Accuracy reporting standards. In addition, the field application has ancillary tools such as a HAAT calculator and terrain profile assistance for defining the right category of a CBSD for a location. The mobile device application makes the job of a CPI easier, while complying with the data Collection and reporting rules as defined by WInnForum.

Some embodiments include a Tool Setup page (not shown). The Tool set up includes a Certified Professional Installer (A CPI, as defined by WInnForum) enters his/her credentials and define templates for the CBRS Transmitter device that he or she wants to work with. The Template for the CBRS Transceiver contains all the CBRS specific FCC certification information as extracted from the FCC and vendor portal. Also in another screen, the user, inputs the UserID, unique for a Service Provider and the Spectrum Access System (SAS), one wants to work with. A commercial contract is required to work with a SAS. The tool has implemented a set of APIs to work with different SASs using the same application.

In addition, the application allows the user to select various transceivers that one wants to work with for a specific deployment type. Each of these transceivers may be selectable by radio button options which allows one to work with the device as if the CBSD transceiver is for Outdoor, Indoor, or Distributed Antenna systems.

FIGS. 15A-15C show an example method to create a CBRS Transceiver (also known as a “CBSD”) through the API. The screens show the process of creating a CBSD with one or more directional antennas attached to a CBSD. The application allows for creation of a CPE (Customer Premise Equipment) for fixed wireless application as well. Other screens may include editing functions to edit the information for a CBSD. When entering CBRS related information, a CPI may be provided functions that allow for example, uploading a floor plan as an image or GeoJSOn format, so that the accuracy requirements for indoor deployment is also met.

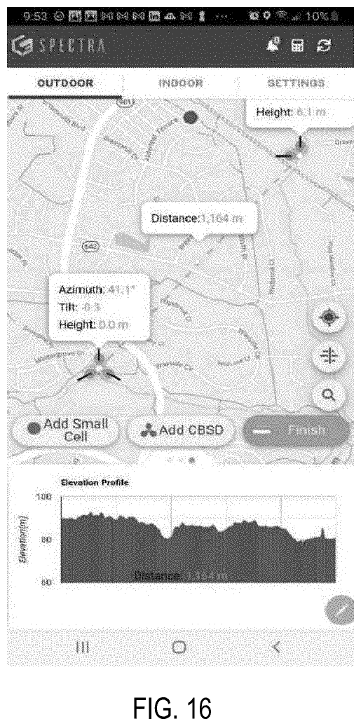

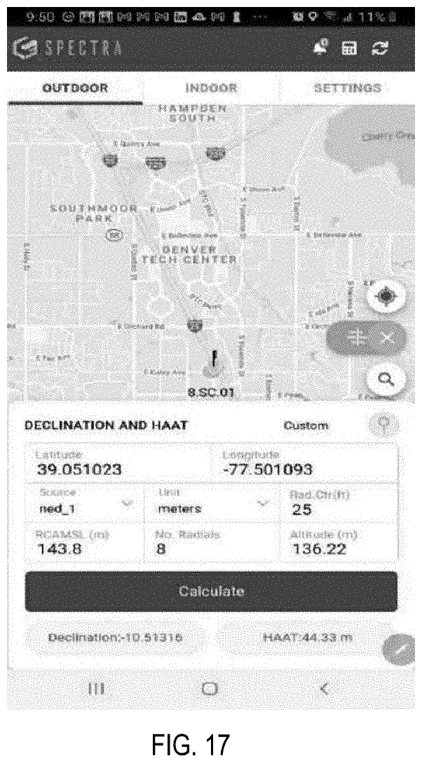

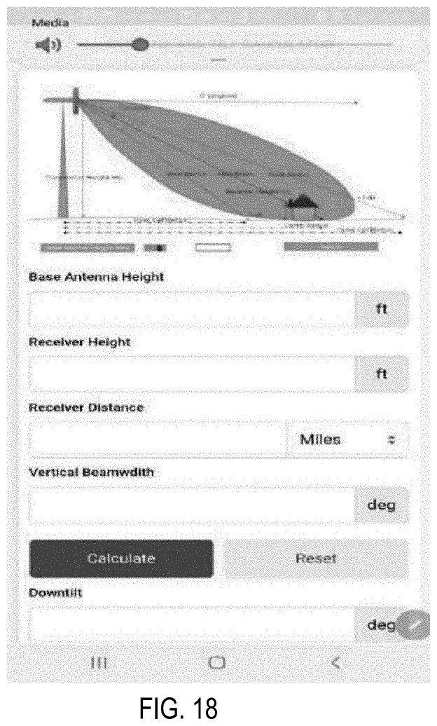

Referring now to FIGS. 16-18, some embodiments provide UI interfaces and functions for calculating the magnetic declination, height above average terrain (HAAT) using for example, three National and Global references and AGL & AMSL references so that this information can be submitted to the SAS. FIG. 16 shows elevation data for an outdoor asset and distance between radio equipment. FIG. 17 shows declination and HAAT data for a location. FIG. 18 shows antenna tilt for an asset relative to a building. As will be appreciated, the above-described characteristics may be determined by the system and in some embodiments, are calculated by the system based on data either automatically obtained for an asset or location, or data input by the installer.

Some embodiments of the system and API may include a notification engine/process for Non-CPI installers to notify CPIs of potential updates to transceiver properties or inform them, if there has been changes that may invalidate specific SAS submissions. In addition, when a CPI informs the SAS of a submission, the application provides error codes for them to rectify the CBSD information when the system determines that the information is inconsistent with standards or known performance.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media may be utilized. In the context of this disclosure, a computer readable storage medium may be any tangible or non-transitory medium that can contain or store a program for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Aspects of the disclosed invention are described below with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A computer program product for generating building entry loss measurements used by certified professional installers of telecommunications equipment, the computer program product comprising a non-transitory computer readable storage medium having computer readable program code embodied therewith, the computer readable program code being configured, when executed by a processor, to:
receive a request from a user, through an application programming interface (API) of a computing device, to determine a building entry loss for a wireless equipment asset located in an indoor space;
draw vector rays emanating from the wireless equipment asset in the indoor space in incremental angles toward an exterior of a building housing the wireless equipment asset; and
for each vector ray, calculate building entry loss in each angle of an outdoor signal on its path to the wireless equipment asset.

2. The computer program product of claim 1, wherein the calculation of building entry loss includes using the lateral, longitudinal, and height position of the wireless equipment asset in the building.

3. The computer program product of claim 1, wherein the calculation of building entry loss includes determining a number of walls between the wireless equipment asset and an exterior wall of the building.

4. The computer program product of claim 3, wherein the calculation of building entry loss includes determining a permittivity of each wall between the wireless equipment asset and an exterior wall of the building.

5. The computer program product of claim 4, wherein the calculation of building entry loss includes a distance from the wireless equipment asset to the exterior wall.

6. The computer program product of claim 5, wherein the computer readable program code is further configured to:
model an indoor environment surrounding the wireless equipment asset;
model a radio signal interference associated with the wireless equipment asset based on the modelled indoor environment; and
display, through the API, the radio signal interference model.

7. The computer program product of claim 1, wherein the computer readable program code is further configured to generate a contour map of signal loss for a floor on which the wireless equipment asset is located.

8. The computer program product of claim 7, wherein the contour map is in a three dimensional format.

9. The computer program product of claim 8, wherein the contour map shows signal loss across multiple floors of the building.

10. The computer program product of claim 1, wherein the computer readable program code is further configured to:
receive from the user, field installation data associated with the wireless equipment asset;
provide the field installation data to a machine learning model;
generate a prediction model of interference strength and radio signal strength associated with the wireless equipment asset based on the field installation data;
provide to the user through the API, a correction analysis associated with installation of the wireless equipment asset, based on the prediction model.

11. A method for generating building entry loss measurements used by certified professional installers of telecommunications equipment, comprising:
receiving a request from a user, through an application programming interface (API) of a computing device, to determine a building entry loss for a wireless equipment asset located in an indoor space;
drawing vector rays emanating from the wireless equipment asset in the indoor space in incremental angles toward an exterior of a building housing the wireless equipment asset; and
for each vector ray, calculating building entry loss in each angle of an outdoor signal on its path to the wireless equipment asset.

12. The method of claim 11, wherein the calculation of building entry loss includes using the lateral, longitudinal, and height position of the wireless equipment asset in the building.

13. The method of claim 11, wherein the calculation of building entry loss includes determining a number of walls between the wireless equipment asset and an exterior wall of the building.

14. The method of claim 11, wherein the calculation of building entry loss includes determining a permittivity of each wall between the wireless equipment asset and an exterior wall of the building.

15. The method of claim 14, wherein the calculation of building entry loss includes a distance from the wireless equipment asset to the exterior wall.

16. The method of claim 15, further comprising:
modelling an indoor environment surrounding the wireless equipment asset;
modelling a radio signal interference associated with the wireless equipment asset based on the modelled indoor environment; and
displaying, through the API, the radio signal interference model.

17. The method of claim 11, further comprising: generating a contour map of signal loss for a floor on which the wireless equipment asset is located.

18. The method of claim 17, wherein the contour map is in a three dimensional format.

19. The method of claim 17, wherein the contour map shows signal loss across multiple floors of the building.

20. The method of claim 11, further comprising:
receiving from the user, field installation data associated with the wireless equipment asset;
providing the field installation data to a machine learning model;
generating a prediction model of interference strength and radio signal strength associated with the wireless equipment asset based on the field installation data; and
providing to the user through the API, a correction analysis associated with installation of the wireless equipment asset, based on the prediction model.
